(19) United States
(12) Patent Application Publication
(10) Pub. No.: US 2005/0156391 A1
(43) Pub. Date: Jul. 21, 2005

(54) Industrial truck with a traveling drive and a place for a passenger

(76) Inventor: Marcel Krenzin, Bad Bramstedt (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/031,274

(22) Filed: Jan. 7, 2005

(30) Foreign Application Priority Data
Jan. 16, 2004 (DE) 10 2004 002 188.0

(51) Int. Cl. B60K 17/344; B60G 17/02

(52) U.S. Cl. 280/5.515

(57) ABSTRACT

An industrial truck with a travel drive which drives a single driving wheel which also is pivotally supported, as a steered wheel, about a vertical axis and has a non-compliant tyre, wherein the driving wheel of industrial trucks featuring a load-dependent driving axle load is supported on the chassis via a spring assembly having a rigid spring characteristic wherein the spring constant of the spring assembly is fixed as follows:

$$\underline{{F}_{Driving wheel at a rated load [ N ]} - {F}_{Driving wheel at no load} [ N ]} <= \\ {C}_{spring system} <= \underline{{F}_{Driving wheel at a rated load [ N ]} - {F}_{Driving wheel at no load } [ N ] }$$

$$2 [ mm ] \qquad 10 [ mm ]$$

where F is the respective contact pressure force of the driving wheel.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

A distinction is made between three-wheel, four-wheel or five-wheel vehicles with regard to the wheel arrangement in industrial trucks, particularly fork-lift trucks. In the three-wheel vehicle, two wheels are configured as load-carrying wheels of wheel-arm supported fork-lift trucks or even as front wheels of so-called balanced-weight fork trucks. The rear area merely supports a driving wheel which additionally is pivotable about a vertical axis for steering purposes. In four-wheel vehicles, the front and rear ends accommodate two wheels or rollers each, e.g. load-carrying wheels in the wheel arms, a driving wheel at the opposed end in the corner area, and a supporting roller at its side.

The driving wheel is pivotable also here about a vertical axis for steering purposes. In five-wheel vehicles, the steered driving wheel is located approximately at the centre of the driving portion of the industrial truck, and one supporting roller each is supported on both sides of the driving wheel so as to be freely pivotable about a vertical axis.

The arrangement described above for the wheels in the vehicle framework of industrial trucks is broken up into the running gear groups below:

1. Three-wheel running gear, statically defined:

1.1 All wheels are immovably connected to the framework, the spring system and damping comforts being solely influenceable by the tyre spring system characteristic.

1.2 The front wheels of balanced-weight fork trucks are supported in spring-loaded suspensions (DE 100 62 565 A1).

1.3 The spring-loaded driving wheel is relieved of load in proportion to the load received (DE 919517).

2. Four-wheel running gear, statically overdefined:

2.1 All wheels are immovably connected vertically to the framework, the spring system and damping comforts being solely influenceable by the tyre spring system characteristic and wheel arm rigidity.

2.2 A spring-loaded supporting roller as combined with a non spring-loaded driving wheel.

2.3 A spring-loaded, cushioned supporting roller as combined with a non spring-loaded driving wheel (DE 298 01 892 U1).

2.4 A hydraulically loaded/lockable supporting roller as combined with a non spring-loaded driving wheel (DE 197 53 412).

2.5 A spring-loaded supporting roller as combined with a spring-loaded driving wheel (U.S. Pat. No. 6,488,297 B2).

3. Four-wheel running gear, statically defined:

3.1 The supporting roller and driving wheel are statically coupled to each other kinematically and are loaded by an ancillary spring (U.S. Pat. No. 6,488,297 B2).

3.2 The supporting and driving wheels are located on a carrier unit which is arranged on a rotational axis so as to swing with respect to the basic framework. Additionally, the carrier unit and basic framework are coupled to spring members (U.S. Pat. No. 6,488,297 B2).

3.3 The wheels of one vehicle axle are connected to each other by steering devices and act upon each other.

3.4 The carrier unit of 3.2 and the steering device of 3.3 are geometrically adjustable and/or lockable in response to the operating parameters.

4. Five-wheel running gear

4.1 Vertically immovable lateral supporting rollers as combined with a vertically movable driving wheel which
a) is pressed to the floor at a constant spring force (U.S. Pat. No. 4,431,084).
b) is pressed to the floor at a load-dependent spring force (EP 0 209 502 B1).
c) is pressed to the floor by a load-dependent lifting kinematics (DE 3904798 A1 and DE 3904798 C2).
d) is pressed to the floor in response to the operating parameters (DE 3402495, EP 0 329 504 B1, GB 2094727).
e) is relieved of load in response to the lifting height (DE 3106027 A1).

4.2 Vertically immovable driving wheel as combined with vertically movable supporting wheels which
a) are pressed to the floor at a constant spring force (EP 0 480 817, EP 0 329 504, EP 2 606 765).
b) are in a floor contact with a cushioner unit (EP 0 584 704).
c) are in a floor contact with a spring/cushioner unit
d) are loaded hydraulically and/or are locked, independently on each other.

4.3 Vertically immovable driving wheel as combined with vertically movable supporting wheels which
a) are pressed to the floor at a constant spring force.
b) are in a floor contact with a spring/cushioner unit
c) are interlockable with a setting member independently of the path.
d) are pressed to the floor by a setting member in response to a load. in a dependent kinematic coupling to each other.

All running gear designs are based on a weighting of the vehicle's lateral stability and traction of the driving wheel. If priority is given to the lateral stability the suspensions for the wheels generating the rocker axles are made rigid, which results in an overdefined wheel end-bearing force situation leading to traction problems on the driving wheel for both four-wheel and five-wheel vehicles.

To obtain a defined driving wheel load, it is necessary to re-open blocked freedom degrees of the wheel bearing. This substantially includes the vertical movement of the driving wheel suspension in five-wheel vehicles and, as an alternative, the vertically movable lateral supporting wheel in four-wheel vehicles.

This also applies to kinematic couplings of the wheels of an axle or the formation of swing axles.

Vertically movable wheel suspensions are supported towards the vehicle framework via spring members or hydraulic cylinders. Additional setting units on the a.m. supporting members allow to vary the respective wheel loads which, in turn, has an impact on the wheel loads of the wheels which are fixedly connected to the framework vertically. Thus, the wheel load on the lateral supporting wheels increases on the same axle if the driving wheel load increases whereas the wheel loads of all wheels are influenced in four-wheel running gears.

Therefore, if the driving wheel load increases lateral stability will decrease so that the vertically rigid attachment of the running gear wheels of the rocker axle goes down in significance. There is a certain ultimate load from which it is inevitably necessary to invert the wheel suspension from “vertically fixed” to “vertically movable”, and vice versa because otherwise unstable driving conditions will arise.

The vertically immovable driving wheel mates with vertically movable lateral supporting rollers which are supported towards the vehicle's framework via springs and cushioners to avoid an increase in dynamic oscillations in cornering. At this stage, the preponderant portion of the entire driving axle load rests on the driving wheel, the so-called “load-oriented driving wheel”, in dependence on the previously made weighting. In extreme situations, the lateral supporting rollers can be vertically interlocked or be reset to a basic position under a control by operating parameters.

Therefore, it can be stated that if five-wheel running gears are used at least one wheel per vehicle axis will be designed as being vertically immovable. The same applies to four-wheel vehicles except for a single case (item 2.5 of U.S. Pat. No. 6,488,297 B2) in which both the driving wheel and supporting roller are supported separately towards the vehicle running gear via springs.

In the running gear designs described above, it is just the vertically immovable wheels of a vehicle axis which are determining for the agreement between the lateral stability and traction capability, on one hand, as is the dominant interface between the road conditions and vehicle framework vibrations, on the other. The shocks from ground are transferred to the running gear in a non-damped condition. This makes itself felt by annoying noise, e.g. when sharp road elevations are run over. Moreover, a non-cushioned transfer of the shock takes place to the driver in the driver's platforms and seating devices.

It is the object of the invention to provide an industrial truck in which the “load-oriented driving wheel” is connected to the vehicle framework such as to satisfy the characteristics below:
a) Resilient evasion from shocks from the road.
b) High cushioning capability to achieve optimum dynamic stability in driving.
c) No adverse impacts on the running gear properties of lateral stability and traction.
d) Directional stability and direct steering properties.
e) Low steering forces.
f) Optimum wear-resistant properties of the driving wheel hoop, specifically under high wheel loads.
g) Minimization of driving noise levels.
h) Minimization of the rolling resistance.

### BRIEF SUMMARY OF THE INVENTION

If the required characteristic are studied by resorting to the solution potential of the known running gear components, it seems that using wheels which have tyres of a particularly large deflection characteristic, the so-called “super-elastic tyres” as are employed in balanced-weight and fork-lift reach trucks, is the closest solution. The use of such hoops has only been limited to the running gear types 1.1 and 2.1 up to now while all of the other running gear designs are equipped with polyurethane tyre wheels which have a very steep tyre deflection characteristic as compared to the “super-elastic wheel”. For an improvement to their traction properties, rubber hoops are also used which, however, have excessively low load-carrying capacities and require large steering forces.

The “super-elastic tyre” only meets the aforementioned properties a), c), and g) very well while all the others are considerably worse than those of the currently used polyurethane tyre wheels. The reasons below can be given here:
b) The cushioning capacity of the hoop is directly dependent on the module of elasticity which co-determines spring rigidity. Hence, the attenuation constant cannot chosen freely. The resultant consequence is that the rate of decline is poor for shocks from the road.
d) The large hoop thickness required for the desired spring rigidity causes the wheel to loose in transverse and torsional rigidity.
e) The pivoting torque of a wheel is proportional to the wheel end-bearing surface which becomes the larger the smaller is the wheel hoop rigidity.
f) The resistance to abrasion of known “super-elastic wheels” is lower than that of polyurethane tyre wheels of common brands.
h) The rolling resistance of a wheel is proportional to the wheel end-bearing surface and becomes the larger the smaller is the wheel hoop rigidity.

The solution of the inventive object is achieved by the features of claim 1.

In the inventive industrial truck, the driving wheel is supported on the chassis via an additional spring assembly having a rigid spring characteristic and a specific attenuation constant, if desired, which approximately depicts the springy behaviour of an elastic tyre whereas the tyre of the driving wheel substantially is non-compliant. Except for balanced-weight fork trucks which are also operated outdoors, industrial trucks usually have wheels with polyurethane tyres of 90-93 Shore A which substantially are non-elastic.

Such a tyre is also provided for the driving wheel of the invention. The design of the spring assembly is such as to give way by no more than 2-10 mm when the load on the industrial truck is maximal.

Since the driving wheel loads are highly different for the individual running gear designs and, hence, tyre geometries also need to be dimensioned individually the spring constant regulation below applies to the inventive drive spring system:

1. For running gears having a load-dependent driving wheel pressure:

$$\underline{{F}_{Driving wheel at a rated load [ N ]} - {F}_{Driving wheel at no load} [ N ]} <= \\ {C}_{spring system} <= \underline{{F}_{Driving wheel at a rated load [ N ]} - {F}_{Driving wheel at no load } [ N ] }$$

$$2 [ mm ] \qquad 10 [ mm ]$$

2. For running gears having a load-independent driving wheel pressure:

$$\underline{{F}_{Driving wheel } [ N ]} <= {C}_{spring system} <= \underline{{F}_{Driving wheel } [ N ]}$$

$$2 [ mm ] \qquad 10 [ mm ]$$

In the invention, the springy property of a super-elastic tyre as is known as such in connection with industrial trucks is incorporated into the spring assembly and the driving wheel itself is equipped with a substantially non-compliant tyre. The possibility of varying the spring constant of a spring involves a large potential of individual agreements as compared to a wheel tyre.

The cushioning properties specific to the running gear now can be equally realized individually by a separate cushioner which acts on the driving wheel suspension. Since the invention relates to running gear axles with a load-oriented driving wheel it is also possible to transfer the desired attenuation characteristic to those wheels by arranging cushioners if there are even more wheels on the axle that inevitably have to be designed to be vertically movable.

This is particularly beneficial because those wheels anyway have an independent spring/cushioner system of their own which merely needs to be adapted.

The invention is applicable with advantage to a three-wheel running gear, but can equally be used for a five-wheel running gear. In the latter case, according to an aspect of the invention, it is useful for the supporting wheels to be supported on the chassis via a spring-actuated cushioner assembly. The spring-actuated cushioner assembly can be configured in a conventional way, e.g. in a form which provides a relatively rigid operation characteristic in the direction of support whereas the relaxation characteristic of the cushioner is of a flat shape. This means that if a load is applied a high resistance is generated whereas the extraction of a supporting wheel following a preceding retraction is performed with relatively no resistance and, therefore, is fast so that if a supporting wheel is retracted while a sharp road elevation is being run over the supporting wheel will rapidly be moved out to the ground again once the elevation is left.

The invention does not result in relevant effects on ground clearance between the floor and the lower edge of the framework. Further, the expenditure is reduced for the framework of the vehicle because it can be made simpler in construction and with regard to its strength.

According to an aspect of the invention, the supporting wheels can also be loaded via a hydraulic or pneumatic adjusting cylinder in order to vary the running gear properties in response to the operating parameters such as to the pressure in the lifting cylinder, the height to which the received load is lifted, the acceleration or deceleration of the fork-lift truck, the steering angle of the driving wheel, the slip of the driving wheel, etc.

However, it is also possible to apply the invention to four-wheel running gears.

The invention will be described in more detail below with reference to the embodiments illustrated in the drawings.

### BRIEF DESCRIPTION OF SEVERAL VIEWS OF THE DRAWINGS

FIG. 1 very schematically shows the suspension of a driving wheel for a three-wheel running gear of an industrial truck.

FIG. 2 shows an alternative detail of FIG. 1.

FIG. 3 very schematically shows the driving wheel of a five-wheel running gear for an industrial truck having supporting rollers on both sides.

FIG. 4 shows the suspension of a supporting roller of the running gear of FIG. 3.

FIG. 5 shows an alternative suspension of a supporting roller of the running gear of FIG. 3.

FIG. 6 very schematically shows the suspension of a driving wheel and supporting roller for an industrial truck having a four-wheel running gear.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

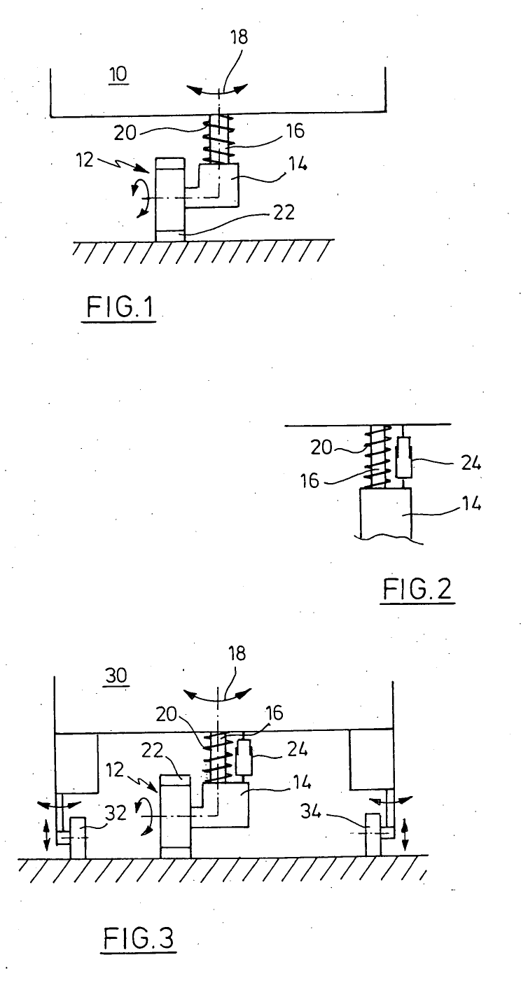

In FIG. 1, the chassis of an industrial truck which is not shown in detail is outlined at 10 and has a three-wheel running gear. The front wheels are not shown, but merely a driving wheel 12 is shown instead on the longitudinal axle of the vehicle that is driven by an engine transmission assembly 14 about a horizontal axis and is pivotally supported about a vertical axis by means of a vertical shaft 16. The latter is done for steering purposes as is outlined by a two-ended arrow 18. The steering device is not shown.

Furthermore, the shaft 16 is displaceable to a limited extent in a vertical direction while being guided in an appropriate guide, which is not shown, however. A spring assembly 20 is provided between the chassis 10 and the engine transmission assembly 14. The design of the spring assembly has been made such as to give way only by a few millimetres, e.g. from 3 to 6 mm, if there is a maximum permissible load on the industrial truck. The spring assembly 20 substantially helps imitate the behaviour of a super-elastic tyre as is normally used for driving wheels of industrial trucks. The driving wheel 12 also has a tyre 22 which is made of Vulkollan, for example, and presents extremely low compliance.

A suspension as is illustrated in FIG. 1 allows to achieve the same behaviour as that of an elastic tyre with no need to assume the disadvantages thereof. A suspension as is shown in FIG. 1 exhibits high positional stability and a steerability of the driving wheel 12 which is better than that for an elastic tyre.

FIG. 2 outlines that a cushioner 24 is provided in addition to the spring assembly 20 to absorb shocks on the driving wheel 12. The characteristic of the cushioner 24 can be such that the operation characteristic is rather steep whereas the relaxation characteristic is flat, on the contrary, so that the driving wheel 12 can be reset relatively rapidly at a minimum retraction in order that a permanent ground contact be maintained.

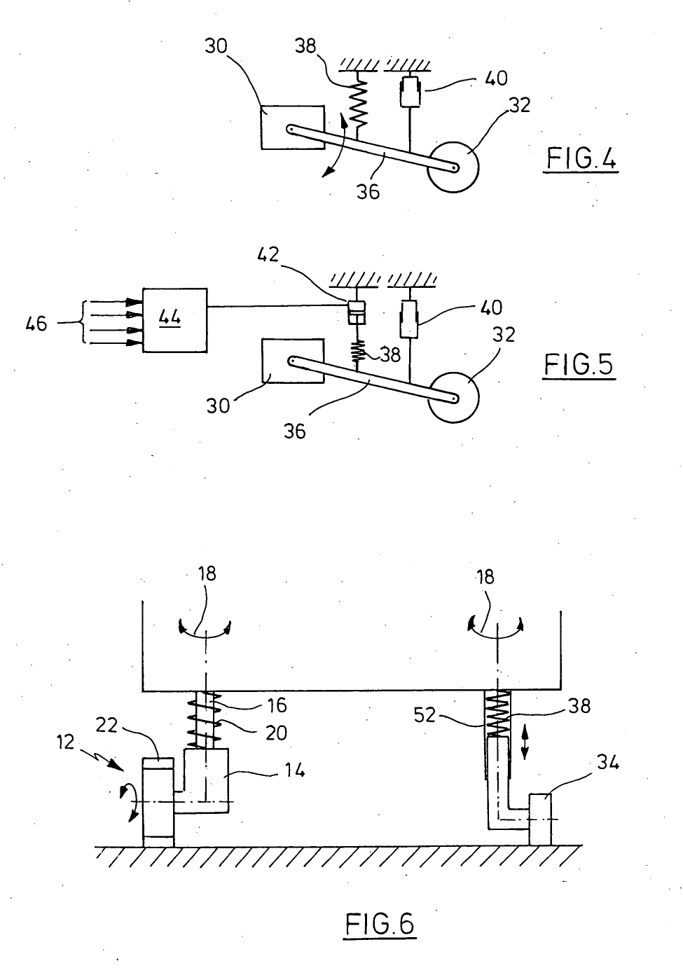

FIG. 3 outlines a five-wheel running gear for an industrial truck in which the chassis 30 again is supported solely via the steerable driving wheel 12. (Since components are used which mostly are identical to those of the embodiment of FIG. 1 they are designated by identical reference numbers.) The two sides of the driving wheel 12 have arranged thereon supporting rollers 32, 34 which are rotatable about both a vertical axis and horizontal axis. This is generally known for supporting rollers. In the present instance, the supporting rollers 32, 34 are supported via a spring attenuation assembly on the chassis 30. Such an assembly is outlined in FIG. 4, for example. It can be seen that the supporting roller 32 is hinged to the chassis 30 via a rocker arm 36 and the rocker arm 36 is supported on the chassis via a spring 38 and an cushioner element 40. It is understood that the representation of FIG. 4, like the one of FIG. 5, merely serves for explanation and its construction can be configured in very different manners. The cushioner element 40 can be given a relatively steep operation characteristic in order to efficiently absorb shocks and efficiently stabilize the vehicle laterally with no need to fear body rolls. In the opposite direction (relaxation characteristic), the cushioner element 40 is extracted against a low resistance to arrange for the spring 38 to maintain the supporting roller 32 always in a ground contact.

In the embodiment of FIG. 5, a hydraulic cylinder 42 is disposed between the spring 38 and the chassis 30. The cylinder 42 is actuated from a controllable pressure source 44 where the pressure is made to depend on a series of different parameters, e.g. the pressure in the lifting cylinder of the industrial truck, the height to which the received load is lifted, the inclination of the industrial truck, the acceleration or deceleration of the vehicle, the steering angle of the driving wheel 12, the slip of the driving wheel 12, etc. This is outlined by the arrows 46 in FIG. 5.

FIG. 6 outlines a chassis 50 of an industrial truck which has a four-wheel running gear where only one driving wheel 12 and one supporting wheel 34 are shown. The suspension of the driving wheel 12 matches that of FIGS. 1 and 3 and, hence, identical components are designated by identical reference numbers. The supporting roller 34 is supported on the chassis via a spring cushioner assembly 52. The spring cushioner assembly approximately has the effect which was described with reference to FIGS. 4 and 5. However, in the embodiment of FIG. 6, it should be noted that unlike in the five-wheel running gear of FIG. 3 the supporting roller 34 is designed in conformity to a load-oriented driving wheel pressure. The spring 38 helps control the distribution of the entire driving axle load to the driving wheel 12 and the supporting wheel 34. The determining feature here is the driving wheel pressure for starting and braking under a rated load.

1. An industrial truck with a travel drive which drives a single driving wheel which also is pivotally supported, as a steered wheel, about a vertical axis and has a non-compliant tyre, characterized in that the driving wheel (12) of industrial trucks featuring a load-dependent driving axle load is supported on the chassis via a spring assembly having a rigid spring characteristic wherein the spring constant of the spring assembly (20) is fixed as follows:
$$\underline{{F}_{Driving wheel at a rated load [ N ]} - {F}_{Driving wheel at no load} [ N ]} <= \\ {C}_{spring system} <= \underline{{F}_{Driving wheel at a rated load [ N ]} - {F}_{Driving wheel at no load } [ N ] }$$
$$2 [ mm ] \qquad 10 [ mm ]$$
where F is the respective contact pressure force of the driving wheel (12).

2. The industrial truck with a travel drive which drives a single driving wheel which also is pivotally supported, as a steered wheel, about a vertical axis and has a non-compliant tire, characterized in that the driving wheel (12) of industrial trucks featuring a load-dependent driving axle load is supported on the chassis (10) via a spring assembly (20) having a rigid spring characteristic wherein the spring constant is determined by the formula:
$$\underline{{F}_{Driving wheel } [ N ]} <= {C}_{spring system} <= \underline{{F}_{Driving wheel } [ N ]}$$
$$2 [ mm ] \qquad 10 [ mm ]$$
where F is the respective pressure force of the driving wheel.

3. The industrial truck according to claim 1, characterized in that the spring assembly (20) has associated therewith a cushioner assembly (24).

4. The industrial truck according to claim 1, characterized in that at least one side of the driving wheel (12) or the same axle of the driving wheel (12) has disposed thereon a vertically movable supporting wheel (32, 34) which is freely pivotable about a vertical axis and is supported on the chassis 30 via a spring-actuated cushioner assembly (38, 40).

5. The industrial truck according to claim 3, characterized in that a supporting wheel disposed on the axle of the driving wheel is provided with a cushioner assembly and the cushioning action for the driving wheel is assumed by the cushioner assembly of the supporting wheel.

6. The industrial truck according to claim 1, characterized in that the compliance of the spring assembly (20) is not superior to from 3 to 6 mm at a maximum permissible load.

7. The industrial truck according to claim 4, characterized in that the supporting wheel (32) is acted on by a power-driven setting member (42) which is controllable by one or more operation parameters of the industrial truck for a variation of the end-bearing force of the supporting roller (32).
